(19) United States
(12) Patent Application Publication
(10) Pub. No.: US 2026/0003063 A1
(43) Pub. Date: Jan. 1, 2026

(54) ULTRA-WIDEBAND CLOCK SYNCHRONIZATION USING NARROWBAND SIGNAL

(71) Applicant: Infineon Technologies AG, Neubiberg (DE)

(72) Inventors: Walther Pachler, Graz (AT); Josef Gruber, St. Ruprecht (AT); Dominic Peter Pirker, Graz (AT); Mathias Gangl, Graz (AT)

(21) Appl. No.: 18/757,639

(22) Filed: Jun. 28, 2024

(51) Int. Cl. G01S 13/76; H04B 1/7183

(52) U.S. Cl. CPC G01S 13/765; H04B 1/7183

(57) ABSTRACT

Systems, methods, and circuitries are provided for using a narrowband carrier wave to generate a timing signal in a ultra wideband device. In one example, an ultra-wideband (UWB) device includes a processor; a memory storing instructions for a ranging process, the instructions for execution by the processor and narrowband (NB) based timing circuitry. The NB based timing circuitry is configured to receive a NB carrier wave and generate a system clock signal. The UWB device includes a UWB transceiver configured to transmit UWB signals or receive UWB signals related and synchronized to the ranging process based on the system clock signal.

### FIELD

The present disclosure relates generally to the field of ultra-wideband (UWB) based ranging systems.

### BACKGROUND

In some positioning systems, two-way ranging (TWR) is performed using UWB signals.

### BRIEF DESCRIPTION OF THE DRAWINGS

Some examples of circuits, apparatuses and/or methods will be described in the following by way of example only. In this context, reference will be made to the accompanying Figures.

FIG. 1 is a flow diagram illustrating an exchange of packets during performance of a ranging session, in accordance with various aspects described.

FIG. 2 is a block diagram of a hybrid ranging system, in accordance with various aspects described.

FIG. 3 is a timing diagram of a ranging session performed by the system of FIG. 2, in accordance with various aspects described.

FIG. 4 is a block diagram of a hybrid ranging system in which a NB carrier wave is used to time UWB signals, in accordance with various aspects described.

FIG. 5 is a timing diagram of a ranging session performed by the system of FIG. 4, in accordance with various aspects described.

FIG. 6 is a block diagram of timing circuitry, in accordance with various aspects described.

FIG. 7 is a flow diagram outlining an exemplary method for performing NB carrier wave based timing in a UWB device, in accordance with various aspects described.

### DETAILED DESCRIPTION

The present disclosure is described with reference to the attached figures. Similar components in various figures may be represented by similar reference characters. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

Ranging is the process of precise detection of the distance between a primary device (referred to herein as an anchor) and a secondary device such as a fob, a tag, or personal electronic device (sometimes referred to herein as a tag). The primary or anchor device may be distinguished from the secondary or tag device in several aspects. The anchor device typically has more processing power than the tag and has access to more energy than the tag by way of additional storage capacity or wired connection to a grid-based power source. The anchor device may be fixed in place while the tag is moveable (e.g., carried by a person or attached to a object that may be moved). In some applications the anchor may be less mobile than the tag, such as a body domain controller serving as an anchor device in a vehicle with key fobs serving as tags. Various portions of this disclosure will identify some devices as primary or anchor devices with other devices as secondary or tag devices. It is to be understood that the functional roles in the disclosed scenarios may be reversed. In other words, the anchor may perform actions ascribed to the tag and the tag may perform actions ascribed to the anchor in some applications.

In some application scenarios, when the distance between the primary device and the secondary device is within a pre-specified limit, some form of authorization, usually in the form of physical access, such as unlocking a door, may be performed by the primary device. Other applications of ranging include inventory tracking, navigation in indoor settings, and device location services.

Ultra-wideband (UWB) radio technology has seen increased adoption in secure ranging due to the waveform's ability to support accurate time of flight estimation and therein a determination of relative position. As compared to narrowband signals, which are modulated sine waves, UWB signals are a train of impulses that transmit information using patterns of pulses. Each pulse is very narrow, typically less than two nanoseconds, and occupies a wide frequency band. This means the pulse has a rising edge that is very steep which allows the receiver of the pulse to very accurately measure the arrival time of the signal. UWB pulses can be distinguished even in noisy environments, and the pulses are more resistant to multipath effects than narrowband signals. Due to the strict spectral mask of UWB signals, the transmit power lies at the noise floor, which means that UWB signals do not interfere with other radio communication systems operating in the same frequency bands.

UWB secure ranging solutions may follow the IEEE 802.15.4z ranging standard, which was finalized in 2020. This standard enhanced the existing IEEE802.15.4a ranging standard with new integrity features, allowing more precise and secure ranging. Another relevant standard is the Car Connectivity Consortium CCC standard which provides an industry standard for secure ranging between UWB anchor devices installed in automobiles and initiator devices such as fobs or smartphones.

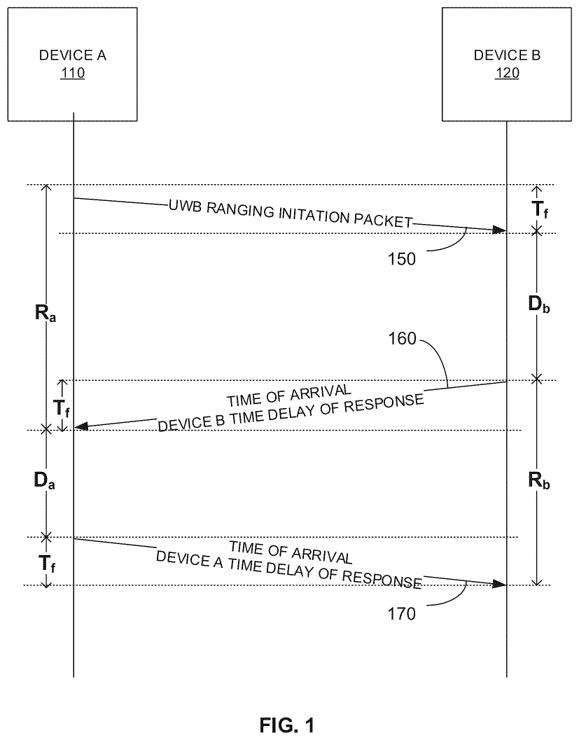

FIG. 1 illustrates an example of two-way ranging (TWR) process in which device A 110 determines its line-of-sight distance from device B 120 based on the time it takes a UWB signal to reach device B, called the time of flight T_{f}. This basic TWR process is the foundation of many different ranging and positioning applications. For example, device A may perform TWR with at least three other devices and use triangulation to determine its position with respect to the other devices. Device A may be an anchor device or tag device and device B may be an anchor device or tag device.

To begin, device A sends a UWB signal carrying a ranging initiation packet 150 to device B. When a defined portion of the packet leaves device A's antenna, device A starts its roundtrip timer Rₐ. This timer will be stopped when the reply from device B is received. The time the packet takes to reach device B is the time of flight T_{f}, which will typically be on the order of tens of nanoseconds. Upon receiving the ranging initiation packet, device B calculates the time of arrival (ToA) of the packet at its antenna and then constructs an acknowledgement packet 160. This acknowledgement packet includes the ToA of the ranging initiation packet 150 as well as the time delay D_{b} between when the ranging initiation packet 150 was received by device B and transmission of the UWB signal carrying the acknowledgement packet 160. When device B transmits the acknowledgment packet 160, device B may starts its own roundtrip timer R_{b}.

Typically D_{b} is several orders of magnitude larger than T_{f}. The length of the packets 150 and 160 is usually on the order of hundreds of microseconds. The processing speed of the device will determine how fast the time of arrival can be calculated and encoded in an acknowledgement packet. Using current generation devices, D_{b} will also be on the order of hundreds of microseconds.

When device A receives the acknowledgement packet 160, it stops its roundtrip timer to determine the roundtrip time Rₐ of the ranging round. Once device A has decoded the acknowledgement packet 160, it may determine

T_{f}=(Rₐ−D_{b})/2.

Since both devices have their own independent and unsynchronized clocks, both devices are affected by imperfections in their timing references. Clock drift is a significant component of these imperfections, which reduce the precision with which the distance may be determined. To reduce clock drift an improve ranging performance, expensive and power-intensive crystal oscillators may be used by the devices in a TWR system.

In double sided two way ranging an additional ranging exchange between the devices is used to reduce the impact of clock drift in the devices in the determination of T_{f}. In this technique, upon receiving the acknowledgement packet 160 device A transmits a UWB signal encoding an additional packet 170 to device B. The additional packet 170 informs device B about the ToA of the acknowledgment packet 160 and the time delay D_{b} between when the acknowledgment packet 160 was received by device A and transmission of the UWB signal carrying the additional packet 170. With the additional information of Dₐ, T_{f} (which is assumed to be equal in every round) may be calculated as

(Rₐ−Dₐ+R_{b}−D_{b})/4.

It can be seen that the processing time of both device A and device B are factors in this determination of T_{f}, reducing the error introduced due to any clock offset between device A and device B. Even with double sided two way ranging, to achieve desired precision in some applications, crystal oscillator circuits are often installed in UWB devices used for ranging.

The IEEE ranging specification is evolving to incorporate NB communication to enhance flexibility in ranging. NB signals may be generally characterized as having a bandwidth less than 499.2 MHz. Bluetooth/WiFi (2.4. GHz) NFC (13.56 MHZ), and UHF (886 MHZ) are examples of narrowband signals. UWB signals may be generally characterized as having a bandwidth greater than 499.2 MHZ. Some proposed solutions include using NB communication for initiating a ranging round such as providing key information, configuring power levels, UWB related parameters, physical layer parameters, and/or channel related parameters used in the ranging round, and defining report quantities or format. NB communications may also be used to report ranging results to a ranging partner device. In this hybrid ranging process, NB communication is leveraged to increase the amount of information that may be exchanged to configure ranging or report results while UWB is used to perform TWR.

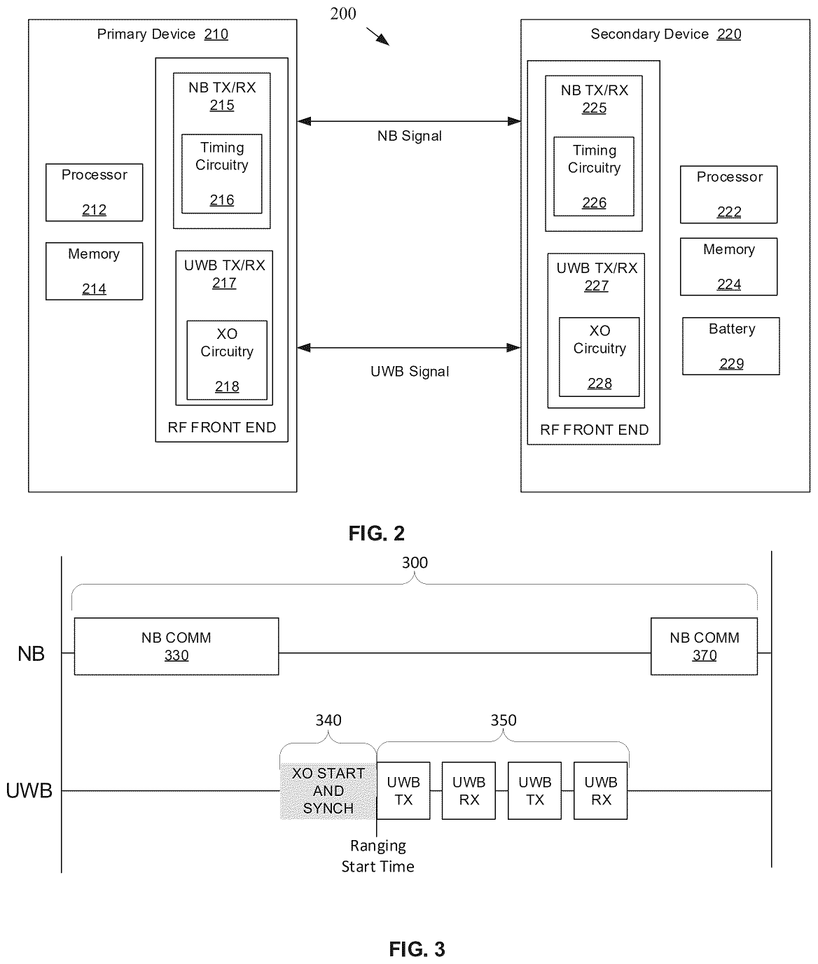

FIG. 2 illustrates an example hybrid ranging system 200 that includes a primary device 210 and a secondary device 220. The primary device 210 includes a processor 212 and memory 214 that enable to primary device to process information communicated by way of narrowband (NB) and UWB signals. An RF front end includes an NB transceiver 215 with timing circuitry 216 and a UWB transceiver 217 with crystal oscillator (XO) circuitry 218. The processor 212 provides data to the RF front end for transmission through the NB channel or UWB channel and receives demodulated NB or UWB signals from the RF front end.

The secondary device 220 includes a battery 229 and a processor 222 and memory 224 that enable to secondary device to decode demodulated NB and UWB signals received from its RF front end and to encode UWB signals and optionally NB signals for transmission by its RF front end. The secondary device RF front end includes an NB transceiver 225 with timing circuitry 226 and a UWB transceiver 227 with crystal oscillator (XO) circuitry 228. The primary device 210 may be larger and have more processing power and access to more power than the secondary device 220, and as such supporting a crystal oscillator circuitry for timing of UWB communication may not significantly impact the design of the primary device. However, the secondary device 220 may have a much simpler design, a smaller battery, and lower price point. Thus, the crystal oscillator circuitry has a more significant impact on the design and cost of the secondary device 220.

To conserve energy, the secondary device 220 may be configured to enter a sleep mode when not involved in a ranging session. This allows the secondary device to shut down the crystal oscillator circuitry 228, which results in significant power savings.

FIG. 3 illustrates an example timeline for a hybrid ranging session 300. To begin the session, initialization NB communication 330 is performed to initiate and/or configure UWB ranging. NB communication 330 transmitted by an initiating device may include an initialization instruction, ranging configuration information (e.g., a number of TWR to be performed, ranging slot timing and duration and so on), and crystal synchronization information. NB communication 330 transmitted by the receiving device may include an indication of device capabilities or acknowledgment of the configured ranging session.

When NB communication 330 occurs while the secondary device is in sleep mode, before the UWB ranging signals of the ranging session may be transmitted or received, during time period 340 the secondary device must first start its crystal oscillator circuitry 228 and, once the crystal oscillator is up to speed, synchronize operation based on the crystal oscillator signal. This causes not insignificant delay with respect to when the ranging phase 350 (e.g., exchange of UWB signals as per FIG. 1) may begin.

After the ranging phase, reporting NB communication 370 occurs which may include reporting of results between the primary and secondary devices or to other devices. After a ranging session is performed, if further ranging sessions are likely, the secondary device may not re-enter sleep mode to avoid having to re-perform the crystal oscillator start up and synchronization operation of 340. This shortens the length of the subsequent ranging session but consumes significant power.

Described herein are systems, methods, and circuitries for utilizing a NB carrier wave as a timing signal for UWB communication. In this manner, crystal oscillator circuitry used to time UWB communication may be omitted from hybrid ranging device design. This reduces cost and power consumption and provides efficient and accurate system-wide synchronization for a positioning system.

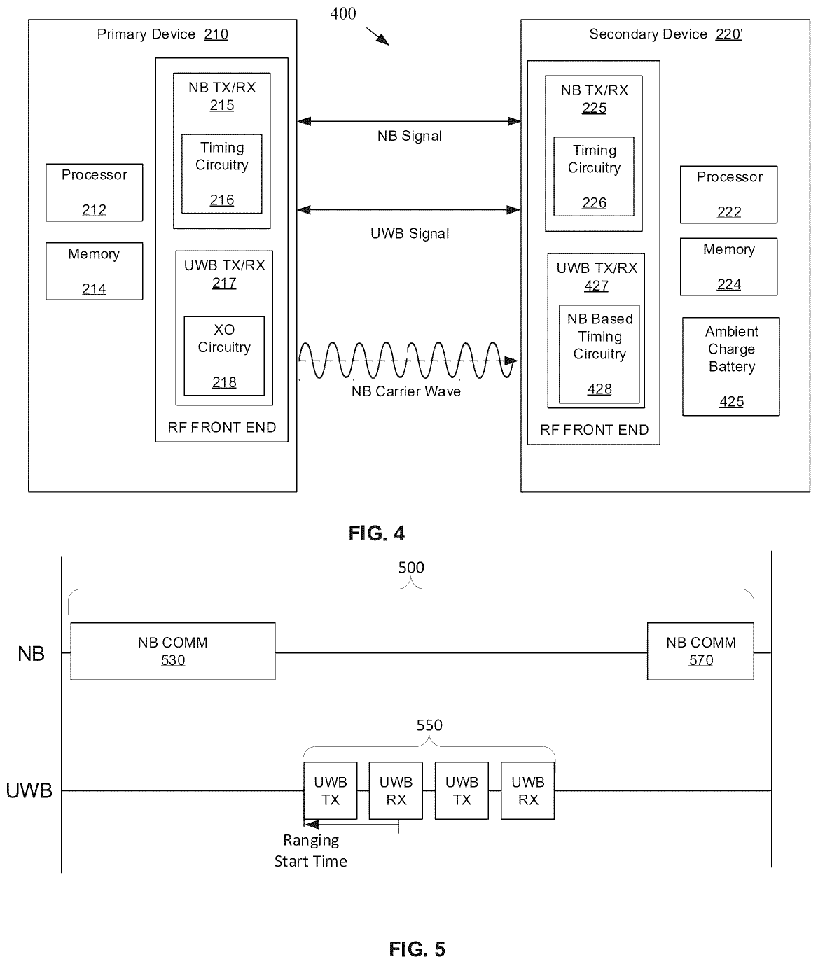

FIG. 4 illustrates an example hybrid ranging system 400 in which the secondary device 220′ includes NB based timing circuitry 428 instead of crystal oscillator circuitry. While the primary device 210 uses the crystal oscillator circuitry 218 for generating a reference clock signal, the secondary device 220′ uses a NB carrier wave to generate the reference clock signal. The NB carrier wave is transmitted by a device, such as the primary device 210′ or a nearby device which may be dedicated for that purpose, in the hybrid ranging system 400. When the primary device 210 is the source of the NB carrier wave, the NB carrier wave corresponds to a carrier wave that is generated by the NB transceiver 215. The NB transceiver modulates the NB carrier wave to generate NB signals. The secondary device 220′ may also include an ambient charge battery 425 that is configured to store energy carried by the NB carrier wave.

Referring to FIG. 5, having a constantly available timing signal reduces the delay between initialization NB communication 530 and the ranging phase 550 of a ranging session 500. No delay is incurred due to crystal oscillator start up and synchronization. Rather, the NB based timing circuitry 428 may be continuously synchronized with the NB carrier wave or quickly synch up with the NB carrier wave in response to the NB communication 530. Further, all devices in a positioning system may utilize the same NB carrier wave to generate their internal reference clock signals. This synchronizes all devices in the positioning system to the same signal, reducing clock offset between devices. Another significant benefit is that the expensive and power hungry crystal oscillator circuitry used to generate timing signals for the UWB signals is eliminated.

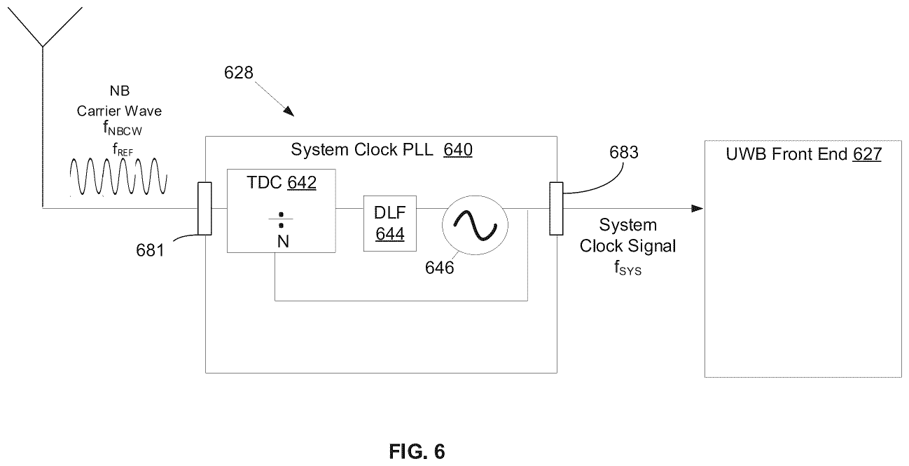

FIG. 6 illustrates an example timing circuitry 628 (timing circuitry 418 may have a similar design) that includes an input or interface 681 that receives the NB carrier wave and an output 683 that provides a system clock signal which may be used to time processing circuits throughout the secondary device. For example, the system clock signal may be used to generate a local oscillator signal for upconverting and downconverting UWB signals. The example timing circuitry 628 includes a phase locked loop (PLL) 640. The PLL inputs a reference clock signal which is usually based on a highly stable quartz or crystal resonator. However, in timing circuitry 628, the reference clock signal is the NB carrier wave with frequency f_{NBCW} (also referred to as f_{REF}).

The PLL 640 locks the phase of an oscillator 646 to the NB carrier wave. A time-to-digital converter (TDC) 642 quantifies a phase difference between the NB carrier wave and the system clock signal output by the PLL 640. The TDC 642 divides the feedback signal by N to quantify the phase difference between an edge of the reference clock and every Nth edge of the UWB signal. The quantity N (called the ratio herein), which can be an integer or an integer portion combined with a sub-integer portion, is used by the TDC to control the relationship between f_{SYS} and f_{NBCW}. The integer portion of the ratio may be adjusted to select a frequency band in which the device is operating while the sub-integer portion of the ratio, if used, allows for finer resolution in selecting a frequency within the band.

The phase difference output by the TDC 642 is filtered by a digital loop filter 644 and the filtered signal is used to adjust the oscillator (DCO) 646 to bring the system clock signal into phase with the narrowband carrier signal. The operation of the UWB PLL 640 can be viewed as a filtered frequency multiplication of the narrowband carrier signal (by ratio N) to generate the system clock signal. This system clock signal or another clock signal derived from the system clock signal may be provided to a UWB front end 627 and used to synchronize the UWB transmissions in the ranging session as well as other operations of the secondary device without need for a crystal oscillator.

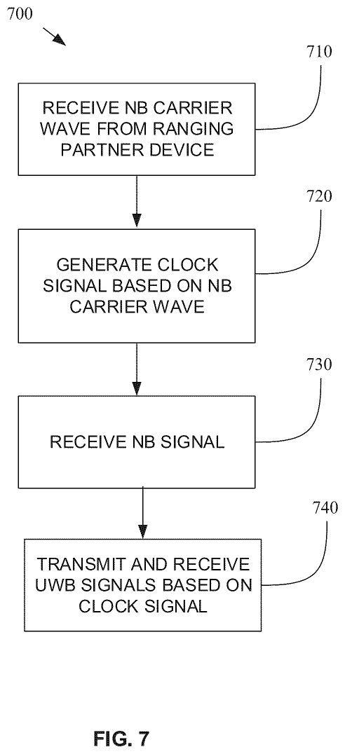

FIG. 7 is a flow diagram outlining an example method 700 for providing NB based timing in a UWB device. The method 700 may be performed by a secondary device 220′ of FIG. 4. The method includes, at 710 receiving a narrowband (NB) carrier wave from a ranging partner device. The ranging partner device (e.g., primary device 210 of FIG. 4) may be a device with which the UWB ranging related signals will be exchanged. In some examples, the NB carrier wave is continuously available. For example, the NB carrier wave may be transmitted when ranging is not being performed or when the UWB device is in a low power state. At 720, the method includes generating a clock signal based on the NB carrier wave. This operation may be performed by NB based timing circuitry (e.g., 428 of FIG. 4) which may include a PLL (e.g., 640 of FIG. 6).

At 730, a NB signal is received that is a modulation of the NB carrier wave. The NB signal may be related the NB communication 530 or 570 of FIG. 5. The NB signal may encode or indicate UWB ranging parameters that configure physical aspects of a UWB signal or aspects of the ranging process such as a number of ranging rounds and so on. At 740, the method includes, based on the clock signal, transmitting and receiving ultra wideband (UWB) signals. The UWB signals may carry time of flight information for performing or synchronizing to a ranging process as outlined in FIG. 1.

In some examples, the NB carrier wave has a frequency between 5.7 GHZ and 6.4 GHz. In some examples, the NB carrier wave is a near field communication (NFC) signal, an ultra high frequency (UHF) signal, a Bluetooth (BLE) signal, or a WiFi signal.

As can be seen from the foregoing description, the disclosed NB based timing solutions utilize NB carrier wave as a timing signal for UWB communication. In this manner, crystal oscillator circuitry is not needed to time UWB communication and may be omitted from ranging device design. This reduces cost and power consumption and provides efficient and accurate system-wide synchronization for a positioning system.

### Examples

Example 1 is an ultra-wideband (UWB) device, including a processor; a memory storing instructions for a ranging process, the instructions for execution by the processor; narrowband (NB) based timing circuitry configured to receive a NB carrier wave and generate a system clock signal; and a UWB transceiver configured to transmit UWB signals or receive UWB signals related and synchronized to the ranging process based on the system clock signal.
Example 2 includes the subject matter of example 1, including or omitting optional elements, wherein the NB based timing circuitry is configured to receive the NB carrier wave from a ranging partner device that transmits a continuously available NB carrier wave and NB signals to the UWB device.
Example 3 includes the subject matter of example 2, including or omitting optional elements, wherein the NB signals encode information used by the processor to control the ranging process.
Example 4 includes the subject matter of example 1, including or omitting optional elements, wherein the NB based timing circuitry includes a phase locked loop (PLL) that includes an oscillator and a feedback control loop that aligns selected edges of a signal output by the oscillator with the NB carrier wave.
Example 5 includes the subject matter of example 1, including or omitting optional elements, further including an ambient charge battery configured to store energy carried by the NB carrier wave.
Example 6 includes the subject matter of example 1, including or omitting optional elements, wherein the NB carrier wave has a frequency between 5.7 GHZ and 6.4 GHz.
Example 7 includes the subject matter of example 1, including or omitting optional elements, wherein the NB carrier wave is a near field communication (NFC) signal, an ultra high frequency (UHF) signal, a Bluetooth (BLE) signal, or a WiFi signal.
Example 8 includes the subject matter of example 1, wherein the NB based timing circuitry does not include a crystal oscillator.
Example 9 is a narrowband (NB) based timing circuitry, including an input coupled to an antenna; timing circuitry coupled to the input, the timing circuitry configured to generate a system clock signal based on a narrowband (NB) carrier wave received by the antenna; and an output coupled to an ultra wideband (UWB) transceiver for use in processing UWB signals.
Example 10 includes the subject matter of example 9, including or omitting optional elements, wherein the timing circuitry includes a phase locked loop (PLL) that includes an oscillator and a feedback control loop that aligns selected edges of a signal output by the oscillator with the NB carrier wave.
Example 11 includes the subject matter of example 9, including or omitting optional elements, further including an ambient charge battery coupled to the timing circuitry, the ambient charge battery configured to store energy carried by the NB carrier wave.
Example 12 includes the subject matter of example 9, including or omitting optional elements, wherein the NB carrier wave has a frequency between 5.7 GHZ and 6.4 GHz.
Example 13 includes the subject matter of example 9, including or omitting optional elements, wherein the NB carrier wave is a near field communication (NFC) signal, an ultra high frequency (UHF) signal, a Bluetooth (BLE) signal, or a WiFi signal.
Example 14 includes the subject matter of example 9, wherein the NB based timing circuitry does not include a crystal oscillator.
Example 14 includes the subject matter of example 9, wherein the NB carrier wave is continuously available.
Example 16 is a method, including receiving a narrowband (NB) carrier wave from a ranging partner device; generating a clock signal based on the NB carrier wave; receiving a NB signal including a modulation of the NB carrier wave; and based on the clock signal, transmitting and receiving ultra wideband (UWB) signals.
Example 17 includes the subject matter of example 16, including or omitting optional elements, wherein the NB signal encodes configuration information for a ranging procedure and the UWB signals encode ranging information.
Example 18 includes the subject matter of example 16, including or omitting optional elements, wherein the NB carrier wave has a frequency between 5.7 GHZ and 6.4 GHz.
Example 19 includes the subject matter of example 16, including or omitting optional elements, wherein the NB carrier wave is a near field communication (NFC) signal, an ultra high frequency (UHF) signal, a Bluetooth (BLE) signal, or a WiFi signal.
Example 20 includes the subject matter of example 16, wherein the NB carrier wave is continuously available.
Example 21 is an apparatus that includes respective means for performing the respective operations or functions of any of claims 1-20.

In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

As used herein, the term provide when used with reference to information or data or a signal encoding data is to be construed broadly as encompassing any manner of communicating the information, data, or signal encoding data either explicitly or implicitly. “Provide” should be construed to encompass transmitting a message that indicates the information or data, storing the information or data in memory accessible to the recipient of the providing, controlling electrical signals on conductors in a circuit to encode the information or data, and so on.

Although specific embodiments/examples/aspects have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the examples as outlined in the present document may be used stand-alone or in combination with the other methods and systems disclosed in this document. In addition, the features outlined in the context of an apparatus are also applicable to a corresponding method, and vice versa. Furthermore, all aspects of the methods and apparatus outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. An ultra-wideband (UWB) device, comprising:
a processor;
a memory storing instructions for a ranging process, the instructions for execution by the processor;
narrowband (NB) based timing circuitry configured to receive a NB carrier wave and generate a system clock signal; and
a UWB transceiver configured to transmit UWB signals or receive UWB signals related and synchronized to the ranging process based on the system clock signal.

2. The UWB device of claim 1, wherein the NB based timing circuitry is configured to receive the NB carrier wave from a ranging partner device that transmits a continuously available NB carrier wave and NB signals to the UWB device.

3. The UWB device of claim 2, wherein the NB signals encode information used by the processor to control the ranging process.

4. The UWB device of claim 1, wherein the NB based timing circuitry comprises a phase locked loop (PLL) that includes an oscillator and a feedback control loop that aligns selected edges of a signal output by the oscillator with the NB carrier wave.

5. The UWB device of claim 1, further comprising an ambient charge battery configured to store energy carried by the NB carrier wave.

6. The UWB device of claim 1, wherein the NB carrier wave has a frequency between 5.7 GHz and 6.4 GHz.

7. The UWB device of claim 1, wherein the NB carrier wave is a near field communication (NFC) signal, an ultra high frequency (UHF) signal, a Bluetooth (BLE) signal, or a WiFi signal.

8. The UWB device of claim 1, wherein the NB based timing circuitry does not include a crystal oscillator.

9. Narrowband (NB) based timing circuitry, comprising:
an input coupled to an antenna;
timing circuitry coupled to the input, the timing circuitry configured to generate a system clock signal based on a narrowband (NB) carrier wave received by the antenna; and
an output coupled to an ultra wideband (UWB) transceiver for use in processing UWB signals.

10. The NB based timing circuitry of claim 9, wherein the timing circuitry comprises a phase locked loop (PLL) that includes an oscillator and a feedback control loop that aligns selected edges of a signal output by the oscillator with the NB carrier wave.

11. The NB based timing circuitry of claim 9, further comprising an ambient charge battery coupled to the timing circuitry, the ambient charge battery configured to store energy carried by the NB carrier wave.

12. The NB based timing circuitry of claim 9, wherein the NB carrier wave has a frequency between 5.7 GHZ and 6.4 GHz.

13. The NB based timing circuitry of claim 9, wherein the NB carrier wave is a near field communication (NFC) signal, an ultra high frequency (UHF) signal, a Bluetooth (BLE) signal, or a WiFi signal.

14. The NB based timing circuitry of claim 9, wherein the NB based timing circuitry does not include a crystal oscillator.

15. The NB based timing circuitry of claim 9, wherein the NB carrier wave is continuously available.

16. A method, comprising:
receiving a narrowband (NB) carrier wave from a ranging partner device;
generating a clock signal based on the NB carrier wave;
receiving a NB signal comprising a modulation of the NB carrier wave; and
based on the clock signal, transmitting and receiving ultra wideband (UWB) signals.

17. The method of claim 16, wherein the NB signal encodes configuration information for a ranging procedure and the UWB signals encode ranging information.

18. The method of claim 16, wherein the NB carrier wave has a frequency between 5.7 GHZ and 6.4 GHz.

19. The method of claim 16, wherein the NB carrier wave is a near field communication (NFC) signal, an ultra high frequency (UHF) signal, a Bluetooth (BLE) signal, or a WiFi signal.

20. The method of claim 16, wherein the NB carrier wave is continuously available.
